(19) United States
(12) Patent Application Publication
(10) Pub. No.: US 2023/0016327 A1
(43) Pub. Date: Jan. 19, 2023

(54) Methods and Apparatuses for Event Reporting

(71) Applicant: Telefonaktiebolaget LM Ericsson (publ), Stockholm (SE)

(72) Inventor: Hongxia Long, Shanghai (CN)

(21) Appl. No.: 17/779,171

(22) PCT Filed: Sep. 11, 2020
(86) PCT No.: PCT/EP2020/075484

§ 371 Date: May 24, 2022

(30) Foreign Application Priority Data
Nov. 29, 2019 (CN) PCT/CN2019/122110

(51) Int. Cl. H04W 76/28; H04W 52/02; H04W 60/02

(52) U.S. Cl. CPC H04W 76/28; H04W 52/0216; H04W 60/02

(57) ABSTRACT

Methods and apparatuses for event reporting are disclosed. According to an embodiment, an access and mobility management function (AMF) entity detects a status of a terminal device changing from unreachable to reachable and sends, to a first entity, a report indicating that the terminal device is reachable. The report contains a maximum availability time until which the terminal device is expected to be reachable.

### TECHNICAL FIELD

Embodiments of the disclosure generally relate to communication, and, more particularly, to methods and apparatuses for event reporting.

### BACKGROUND

This section introduces aspects that may facilitate better understanding of the present disclosure. Accordingly, the statements of this section are to be read in this light and are not to be understood as admissions about what is in the prior art or what is not in the prior art.

According to section 5.31.7 of the 3rd generation partnership project (3GPP) technical specification (TS) 23.501 V16.2.0, to enable user equipment (UE) power saving and to enhance mobile terminated (MT) reachability while using mobile initiated connection only (MICO) mode, e.g. for cellular Internet of things (CIoT), the following features are specified: extended discontinuous reception (DRX) for connection management idle (CM-IDLE) and CM-CONNECTED with radio resource control inactive (RRC-INACTIVE); MICO mode with extended connected time; MICO mode with active time; and MICO mode and periodic registration timer control.

The UE and the network may negotiate over non-access stratum (NAS) signaling the use of extended idle mode DRX for reducing its power consumption, while being available for MT data and/or network originated procedures within a certain delay dependent on the DRX cycle value. The specific negotiation procedure handling is described in 3GPP TS 23.502.

Applications that want to use extended idle mode DRX need to consider specific handling of mobile terminating services or data transfers, and in particular they need to consider the delay tolerance of mobile terminated data. A network side application may send mobile terminated data, a short message service (SMS), or a device trigger, and needs to be aware that extended idle mode DRX may be in place. A UE should request for extended idle mode DRX only when all expected mobile terminating communication is tolerant to delay.

For wideband evolved universal terrestrial radio access (WB-E-UTRA) connected to the 5th generation core (5GC), the extended idle mode DRX value range will consist of values starting from 5.12 s (i.e. 5.12 s, 10.24 s, 20.48 s, etc.) up to a maximum of 2621.44 s (almost 44 min). For narrowband IoT (NB-IoT), the extended idle mode DRX value range will start from 20.48 s (i.e., 20.48 s, 40.96 s, 81.92, etc.) up to a maximum of 10485.76 s (almost 3 hours) (see 3GPP TS 36.304). The extended idle mode DRX cycle length is negotiated via NAS signalling. The access and mobility management function (AMF) includes the extended idle mode DRX cycle length for WB-E-UTRA or NB-IoT in paging message to assist the next generation radio access network (NG-RAN) node in paging the UE.

A hyper system frame number (H-SFN) frame structure is defined on top of the SFN used for regular idle mode DRX. Each H-SFN value corresponds to a cycle of the legacy SFN of 1024 radio frames, i.e. 10.24 s. When extended idle mode DRX is enabled for a UE, the UE is reachable for paging in specific paging hyperframes (PH), which is a specific set of H-SFN values. The PH computation is a formula that is function of the extended idle mode DRX cycle, and a UE specific identifier, as described in TS 36.304. This value can be computed at all UEs and AMFs without need for signalling. The AMF includes the extended idle mode DRX cycle length and the paging time window (PTW) length in paging message to assist the NG-RAN nodes in paging the UE.

The AMF also assigns a paging time window length, and provides this value to the UE during Registration Update procedures together with the extended idle mode DRX cycle length. The UE first paging occasion is within the paging hyperframe as described in TS 36.304. The UE is assumed reachable for paging within the paging time window. The start and end of the paging time window is described in TS 36.304. After the paging time window length, the AMF considers the UE unreachable for paging until the next paging hyperframe.

With respect to MICO mode with extended connected time, when a UE, using MICO mode, initiates mobile originating (MO) signalling or MO data and the AMF is aware of pending or expected MT traffic, the AMF may keep the UE in CM-CONNECTED state and the RAN may keep the UE in RRC-CONNECTED state for an extended connected time period in order to ensure the downlink data and/or signalling is delivered to the UE. The extended connected time is determined by the AMF and is based on local configuration and/or the maximum response time, if provided by the unified data management (UDM).

The AMF maintains the N2 connection for at least the extended connected time and provides the extended connected time value to the RAN. The extended connected time value indicates the minimum time the RAN should keep the UE in RRC-CONNECTED state regardless of inactivity. The extended connected time value is provided to the RAN together with the NAS Registration Accept message or NAS Service Accept message.

With respect to MICO mode with active time, during a Registration procedure the UE may optionally request an active time value from the AMF as part of MICO mode negotiation. In response, if the AMF receives an active time value from the UE and determines that the MICO mode is allowed for the UE, the AMF may assign an active time value for the UE, e.g. based on local configuration, expected UE behavior if available, UE requested active time value, UE subscription information and network policies, and indicates it to the UE during Registration procedure. When an active time value is assigned to the UE, the AMF shall consider the UE reachable for paging after the transition from CM-CONNECTED to CM-IDLE for the duration of the active time.

The UE and AMF shall set a timer corresponding to the active time value negotiated during the most recent Registration procedure. The UE and AMF shall start the timer upon entering CM-IDLE state from CM-CONNECTED. When the timer expires (i.e. reaches the active time), the UE enters MICO mode and the AMF can deduce that the UE has entered MICO mode and is not available for paging. If the UE enters CM-CONNECTED state before the timer expires, the UE and AMF shall stop and reset the timer. If no active time value was negotiated during the most recent Registration procedure, the UE shall not start the timer and it shall instead enter MICO mode directly upon entering CM-IDLE state.

With respect to MICO mode and periodic registration timer control, for a UE in MICO mode, if the expected UE behavior indicates absence of downlink (DL) communication, the AMF may allocate a large periodic registration timer value to the UE so that the UE can maximize power saving between periodic registration updates.

If the expected UE behavior indicates scheduled DL communication, the AMF should allocate a periodic registration timer value such that the UE performs periodic registration update to renegotiate MICO mode just before or at the scheduled DL communication time.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for event reporting.

According to a first aspect of the disclosure, there is provided a method performed by a network node implementing an access and mobility management function (AMF) entity. The method may comprise detecting a status of a terminal device changing from unreachable to reachable. The method may further comprise sending, to a first entity, a report indicating that the terminal device is reachable. The report may contain the maximum availability time until which the terminal device is expected to be reachable. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

In this way, it is possible for a service consumer to use the reported maximum availability time to schedule a message delivery to the terminal device.

In an embodiment of the disclosure, the maximum availability time may indicate an absolute time point.

In an embodiment of the disclosure, the method may further comprise receiving, from a second entity, a subscription request for event reporting about reachability of the terminal device. The report may be sent based on the subscription request.

In an embodiment of the disclosure, the maximum availability time may be derived by determining a time period during which the terminal device is to keep reachable after the status of the terminal device changes from unreachable to reachable. The maximum availability time may be derived by determining, as the maximum availability time, current time plus a length of the time period.

In an embodiment of the disclosure, the second entity may be one of a network exposure function, NEF, entity, a network data analytics function, NWDAF, entity, a unified data management (UDM) entity and a session management function (SMF) entity.

In an embodiment of the disclosure, the first entity may be one of: a UDM entity, a network exposure function (NEF) entity, an application function (AF) entity, a short message service (SMS) entity, a service capability server (SCS) entity, an application server (AS) entity, an SMF entity and a user plane function (UPF) entity.

In an embodiment of the disclosure, the first entity may be one of an AF entity, an SMS entity, an SCS entity, an AS entity, an SMF entity, a UPF entity and an NEF entity. The maximum availability time may be used by the first entity to prioritize delivering of messages.

According to a second aspect of the disclosure, there is provided a method performed by a network node implementing UDM entity. The method may comprise receiving, from an AMF entity, a first report indicating that a terminal device is reachable. The first report may contain a maximum availability time until which the terminal device is expected to be reachable. The method may further comprise sending, to a third entity, a second report indicating that the terminal device is reachable. The second report may contain the maximum availability time. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

In this way, it is possible for a service consumer to use the reported maximum availability time to schedule a message delivery to the terminal device.

In an embodiment of the disclosure, the method may further comprise sending, to the AMF entity, a first subscription request for event reporting about reachability of the terminal device, in response to a trigger event indicating that event reporting about reachability of the terminal device is required by the third entity.

In an embodiment of the disclosure, the trigger event may be at least one of: receiving, from a SMS gateway mobile services switching center (SMS-GMSC), a message indicating that an SMS delivery for the terminal device fails; and receiving, from an NEF entity, a second subscription request for event reporting about reachability of the terminal device.

In an embodiment of the disclosure, the third entity may be one of: an NEF entity, an AF entity, an SMS entity, an SCS entity and an AS entity.

According to a third aspect of the disclosure, there is provided a method performed by a network node implementing an NEF entity. The method may comprise receiving, from a UDM entity or an AMF entity, a first report indicating that a terminal device is reachable. The first report may contain a maximum availability time until which the terminal device is expected to be reachable. The method may further comprise sending, to a fourth entity, a second report indicating that the terminal device is reachable. The second report may contain the maximum availability time. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

In this way, it is possible for a service consumer to use the reported maximum availability time to schedule a message delivery to the terminal device.

In an embodiment of the disclosure, the method may further comprise receiving, from the fourth entity, a first subscription request for event reporting about reachability of the terminal device. The method may further comprise sending, to the UDM entity, a second subscription request for event reporting about reachability of the terminal device.

In an embodiment of the disclosure, the fourth entity may be one of: an AF entity; an SCS entity; and an AS entity.

According to a fourth aspect of the disclosure, there is provided a method performed by a network node implementing a service consumer. The method may comprise receiving, from a service provider, one or more reports indicating that one or more terminal devices are reachable. Each of the one or more reports may contain a maximum availability time until which a terminal device is expected to be reachable. The method may further comprise sending one or more messages to the one or more terminal devices based on the maximum availability times of the one or more terminal devices. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

In this way, the efficiency of message delivery to the terminal device(s) can be improved.

In an embodiment of the disclosure, a plurality of reports indicating that a plurality of terminal devices are reachable may be received. A plurality of messages may be sent to the plurality of terminal devices by ordering the messages based on the maximum availability times of the plurality of terminal devices.

In an embodiment of the disclosure, the messages may be ordered in an ascending order of the maximum availability times of the plurality of terminal devices. The messages may be sent to the plurality of terminal devices in the ascending order of the maximum availability times.

In an embodiment of the disclosure, the one or more messages may be SMS messages or the one or more messages are used for non-Internet protocol (non-IP) data delivery (NIDD).

In an embodiment of the disclosure, the service provider may be one of: a UDM entity, an NEF entity, an AMF entity and an SMF entity.

In an embodiment of the disclosure, the service consumer may be one of: an SMS entity, an AF entity, an SCS entity, an AS entity, an NEF entity, an SMF entity and a UPF entity.

According to a fifth aspect of the disclosure, there is provided a network node implementing an AMF entity. The AMF entity may comprise at least one processor and at least one memory. The at least one memory may contain instructions executable by the at least one processor, whereby the AMF entity may be operative to detect a status of a terminal device changing from unreachable to reachable. The AMF entity may be further operative to send, to a first entity, a report indicating that the terminal device is reachable. The report may contain a maximum availability time until which the terminal device is expected to be reachable. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

In an embodiment of the disclosure, the AMF entity may be operative to perform the method according to the above first aspect.

According to a sixth aspect of the disclosure, there is provided a network node implementing UDM entity. The UDM entity may comprise at least one processor and at least one memory. The at least one memory may contain instructions executable by the at least one processor, whereby the UDM entity may be operative to receive, from an AMF entity, a first report indicating that a terminal device is reachable. The first report may contain a maximum availability time until which the terminal device is expected to be reachable. The UDM entity may be further operative to send, to a third entity, a second report indicating that the terminal device is reachable. The second report may contain the maximum availability time. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

In an embodiment of the disclosure, the UDM entity may be operative to perform the method according to the above second aspect.

According to a seventh aspect of the disclosure, there is provided a network node implementing an NEF entity. The NEF entity may comprise at least one processor and at least one memory. The at least one memory may contain instructions executable by the at least one processor, whereby the NEF entity may be operative to receive, from a UDM entity or an AMF entity, a first report indicating that a terminal device is reachable. The first report may contain a maximum availability time until which the terminal device is expected to be reachable. The NEF entity may be further operative to send, to a fourth entity, a second report indicating that the terminal device is reachable. The second report may contain the maximum availability time. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

In an embodiment of the disclosure, the NEF entity may be operative to perform the method according to the above third aspect.

According to an eighth aspect of the disclosure, there is provided a network node implementing a service consumer. The service consumer may comprise at least one processor and at least one memory. The at least one memory may contain instructions executable by the at least one processor, whereby the service consumer may be operative to receive, from a service provider, one or more reports indicating that one or more terminal devices are reachable. Each of the one or more reports may contain a maximum availability time until which a terminal device is expected to be reachable. The service consumer may be further operative to send one or more messages to the one or more terminal devices based on the maximum availability times of the one or more terminal devices. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

In an embodiment of the disclosure, the service consumer may be operative to perform the method according to the above fourth aspect.

According to a ninth aspect of the disclosure, there is provided a computer program product. The computer program product may comprise instructions which when executed by at least one processor, cause the at least one processor to perform the method according to any of the above first to fourth aspects.

According to a tenth aspect of the disclosure, there is provided a computer readable storage medium. The computer readable storage medium may comprise instructions which when executed by at least one processor, cause the at least one processor to perform the method according to any of the above first to fourth aspects.

According to an eleventh aspect of the disclosure, there is provided a network node implementing an AMF entity. The AMF entity may comprise a detection module for detecting a status of a terminal device changing from unreachable to reachable. The AMF entity may further comprise a sending module for sending, to a first entity, a report indicating that the terminal device is reachable. The report may contain the maximum availability time until which the terminal device is expected to be reachable. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

According to a twelfth aspect of the disclosure, there is provided a network node implementing a UDM entity. The UDM entity may comprise a reception module for receiving, from an AMF entity, a first report indicating that a terminal device is reachable. The first report may contain a maximum availability time until which the terminal device is expected to be reachable. The UDM entity may further comprise a sending module for sending, to a third entity, a second report indicating that the terminal device is reachable. The second report may contain the maximum availability time. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

According to a thirteenth aspect of the disclosure, there is provided a network node implementing an NEF entity. The NEF entity may comprise a reception module for receiving, from a UDM entity or an AMF entity, a first report indicating that a terminal device is reachable. The first report may contain a maximum availability time until which the terminal device is expected to be reachable. The NEF entity may further comprise a sending module for sending, to a fourth entity, a second report indicating that the terminal device is reachable. The second report may contain the maximum availability time. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

According to an fourteenth aspect of the disclosure, there is provided a network node implementing a service consumer. The service consumer may comprise a reception module for receiving, from a service provider, one or more reports indicating that one or more terminal devices are reachable. Each of the one or more reports may contain a maximum availability time until which a terminal device is expected to be reachable. The service consumer may further comprise a sending module for sending one or more messages to the one or more terminal devices based on the maximum availability times of the one or more terminal devices. The maximum availability time may be derived based on a power saving configuration of the terminal device. The power saving configuration of the terminal device may comprise one or more of: at least one parameter about extended connected time for mobile initiated connection only (MICO) mode; at least one parameter about active time for MICO mode; and at least one parameter about periodic registration timer control for MICO mode.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating an exemplary communication system into which an embodiment of the disclosure is applicable;

FIG. 2 is a flowchart illustrating a method implemented at an AMF entity according to an embodiment of the disclosure;

FIG. 3 is a flowchart illustrating a method implemented at an AMF entity according to another embodiment of the disclosure;

FIG. 4 is a flowchart for explaining the method of FIG. 2;

FIG. 5 is a flowchart illustrating a method implemented at a UDM entity according to an embodiment of the disclosure;

FIG. 6 is a flowchart illustrating a method implemented at a UDM entity according to another embodiment of the disclosure;

FIG. 7 is a flowchart illustrating a method implemented at an NEF entity according to an embodiment of the disclosure;

FIG. 8 is a flowchart illustrating a method implemented at an NEF entity according to another embodiment of the disclosure;

FIG. 9 is a flowchart illustrating a method implemented at a service consumer according to an embodiment of the disclosure;

FIGS. 10A-10B are flowcharts illustrating an exemplary process according to an embodiment of the disclosure;

FIGS. 11A-11B are flowcharts illustrating an exemplary process according to an embodiment of the disclosure;

FIGS. 12A-12B are flowcharts illustrating an exemplary process according to an embodiment of the disclosure;

FIG. 13 is a block diagram showing an apparatus suitable for use in practicing some embodiments of the disclosure;

FIG. 14 is a block diagram showing an AMF entity according to an embodiment of the disclosure;

FIG. 15 is a block diagram showing a UDM entity according to an embodiment of the disclosure;

FIG. 16 is a block diagram showing an NEF entity according to an embodiment of the disclosure; and

FIG. 17 is a block diagram showing a service consumer according to an embodiment of the disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

The Subscribe service operation is invoked by a network function (NF) service consumer, e.g. NEF, towards the AMF, when it needs to create a subscription to monitor at least one event relevant to the AMF. The NF service consumer may subscribe to multiple events in a subscription. A subscription may be associated with one UE, a group of UEs or any UE. The NF service consumer shall request to create a new subscription by using hypertext transfer protocol (HTTP) method POST with uniform resource identifier (URI) of the subscriptions collection, see section 6.2.3.2 of 3GPP TS 29.518 V16.1.1. More details about the event subscription from AMF can be obtained from section 5.3.2.2.2 of TS 29.518.

The Notify service operation is invoked by the AMF, to send a notification, towards the notification URI, when certain event included in the subscription has taken place. The AMF shall use the HTTP method POST, using the notification URI received in the subscription creation as specified in section 5.3.2.2.2 of TS 29.518, including e.g. the subscription identifier (ID), Event ID(s) for which event has happened, notification correlation ID provided by the NF service consumer at the time of event subscription, to send a notification. Additionally, the Notify service operation shall also be invoked by the AMF, when there is a change of AMF during UE mobility procedures and if the subscription Id changes (i.e. Registration procedures and Handover procedures). Table 6.2.6.2.4-1 and Table 6.2.6.2.5-1 of TS 29.518 show the definitions of data structures AmfEventNotification and AmfEventReport used for AMF event notification. More details about the AMF event notification can be obtained from section 5.3.2.4 of TS 29.518.

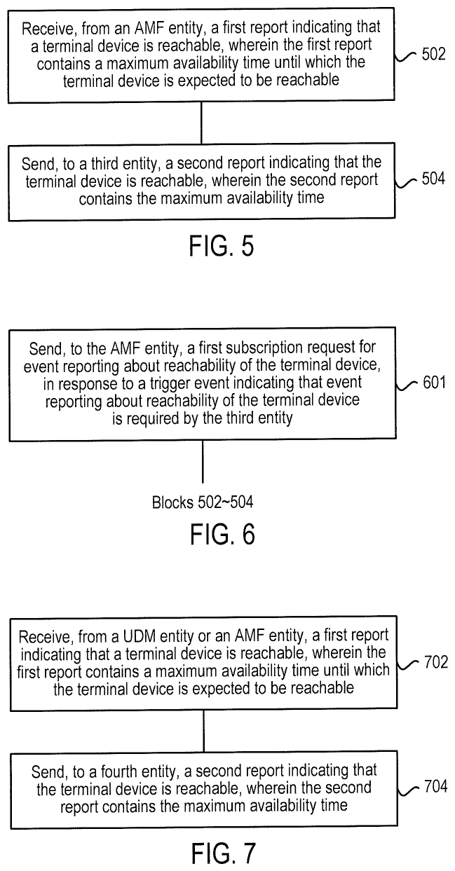

FIG. 5.5.2.2.2-1 of 3GPP TS 29.503 V16.1.0 shows a scenario where the NF service consumer sends a request to the UDM to subscribe to notifications of event occurrence. The request contains a callback URI, the type of event that is monitored and additional information e.g. event filters and reporting options. More details can be obtained from section 5.5.2.2.2 of TS 29.503.

FIG. 5.5.2.4.2-1 of TS 29.503 shows a scenario where the UDM notifies the NF service consumer (that has subscribed to receive such notification) about occurrence of an event. The request contains the callbackReference URI as previously received in the EeSubscription (see section 6.4.6.2.2 of TS 29.503). Table 6.4.6.2.4-1 and Table 6.4.6.2.12-1 of TS 29.503 show the definitions of data structures MonitoringReport and ReachabilityForSmsReport used for UDM event notification. More details can be obtained from section 5.5.2.4.2 of TS 29.503.

High latency communication may be used to handle MT communication with UEs being unreachable while using power saving functions as described hereinbefore. “High latency” refers to the initial response time before normal exchange of packets is established. That is, the time it takes before a UE has woken up from its power saving state and responded to an initial downlink packet or signal.

High latency data communication is supported by extended buffering of downlink data in the AF or user plane function (UPF) or session management function (SMF) or NEF when a UE is using power saving function in CM-IDLE and not reachable. In addition, high latency SMS communication is supported by buffering of mobile terminated SMS (MT-SMS) in the SMS service center (SMS-SC) when a UE is using power saving function and not reachable.

UE reachability indicates when the UE becomes reachable for sending either SMS or downlink data to the UE, which is detected in response to the UE's transition to CM-CONNECTED mode (for a UE using power saving mode or extended idle mode DRX) or when the UE will become reachable for paging (for a UE using extended idle mode DRX). This monitoring event supports UE reachability for SMS and reachability for data. Only a one-time monitoring request for reachability for SMS is supported.

For high latency data communication, AF or UPF or SMF or NEF should serve multiple subscribers. So extended buffering of downlink data in the AF or UPF or SMF or NEF could be for multiple UEs. In addition, for high latency SMS communication, the SMS-SC should serve multiple subscribers, so the buffered SMS messages in SMS-SC could be for multiple UEs.

However, in the prior art, the UE reachability report described hereinbefore does not contain information about how long the UE could keep available after wakeup before entering into sleep mode again. As a result, if there are multiple SMS messages or extended data buffered for different UEs, it is not possible for the service entities (e.g. the SMS-SC for SMS communication, the AF or UPF or SMF or NEF for data delivery) to prioritize the SMS or data delivery for different UEs. The worst case would be that certain UEs will never get chance to receive the message from the service entities.

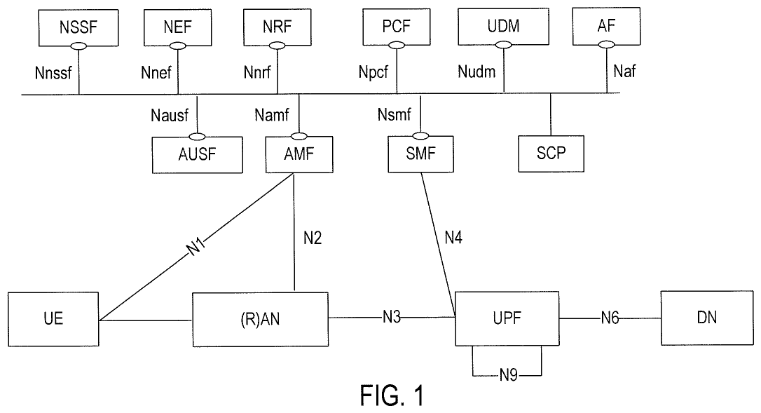

The present disclosure proposes an improved solution for event reporting. Hereinafter, the solution will be described in detail with reference to FIGS. 1-17.

FIG. 1 is a diagram showing an exemplary communication system into which an embodiment of the disclosure is applicable. As shown, the communication system comprises a user equipment (UE), a (radio) access network ((R)AN), a user plane function (UPF), a data network (DN), an authentication server function (AUSF), an access and mobility management function (AMF), a session management function (SMF), a service communication proxy (SCP), a network slice selection function (NSSF), a network exposure function (NEF), a network repository function (NRF), a policy control function (PCF), a unified data management (UDM) and an application function (AF). The functional description of the above entities is specified in section 6 of 3GPP TS 23.501 V16.2.0, which is incorporated herein by reference in its entirety.

Note that within the context of this disclosure, the term terminal device (or UE) used herein may also be referred to as, for example, access terminal, mobile station, mobile unit, subscriber station, or the like. It may refer to any (a stationary or mobile) end device that can access a wireless communication network and receive services therefrom. By way of example and not limitation, the UE may include a portable computer, an image capture terminal device such as a digital camera, a gaming terminal device, a music storage and playback appliance, a mobile phone, a cellular phone, a smart phone, a tablet, a wearable device, a personal digital assistant (PDA), an integrated or embedded wireless card, an externally plugged in wireless card, or the like.

In an Internet of things (IoT) scenario, a terminal device (or UE) may represent a machine or other device that performs monitoring and/or measurements, and transmits the results of such monitoring and/or measurements to another terminal device (or UE) and/or a network equipment. In this case, the terminal device (or UE) may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

As used herein, the term “communication system” refers to a system following any suitable communication standards, such as the first generation (1G), 2G, 2.5G, 2.75G, 3G, 4G, 4.5G, 5G communication protocols, and/or any other protocols either currently known or to be developed in the future. Furthermore, the communications between a terminal device and a network node in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future. In addition, the specific terms used herein do not limit the present disclosure only to the communication system related to the specific terms, which however can be more generally applied to other communication systems.

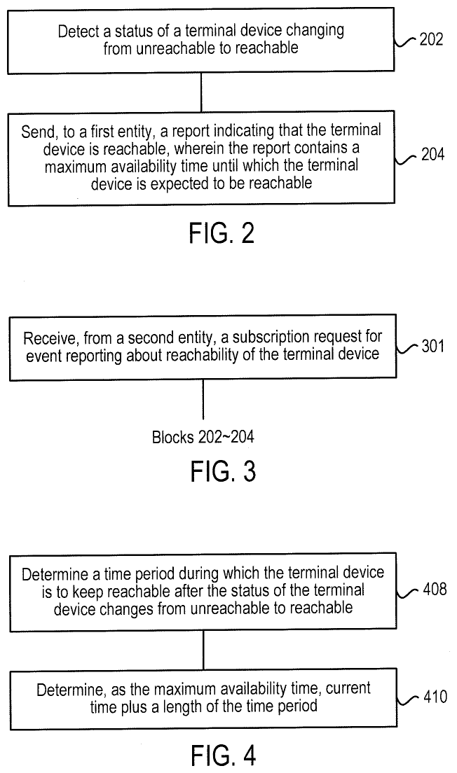

FIG. 2 is a flowchart illustrating a method implemented at an AMF entity according to an embodiment of the disclosure. At block 202, the AMF entity detects a status of a terminal device changing from unreachable to reachable. Since the AMF entity has the functionality of reachability management, it can detect such status change. At block 204, the AMF entity sends, to a first entity, a report indicating that the terminal device is reachable. The report contains a maximum availability time until which the terminal device is expected to be reachable. In this way, it is possible for a service consumer to use the reported maximum availability time to schedule a message delivery to the terminal device.

As an example, the first entity may be a UDM entity or an NEF entity, which may be indicated as a destination entity in a subscription request received from the UDM entity. As another example, the first entity may be an SMF entity, which may be indicated as a destination entity in a subscription request received from the SMF entity. In the above examples, the report may be directly sent to the UDM entity or the NEF entity or the SMF entity. Other examples of the first entity may include, but not limited to, an AF entity, an SMS entity (e.g. SMS-SC), an SCS entity, an AS entity and a UPF entity. In this case, the report may be sent to the AF entity or the SMS entity or the SCS/AS entity indirectly via the UDM entity or the NEF entity, or may be sent to the UPF entity indirectly via the SMF entity. As a result, the maximum availability time may be used by the first entity (e.g. the AF entity, the SMS entity, the SCS/AS entity, the SMF entity, the UPF entity, or the NEF entity) to prioritize delivering of messages.

For example, the AMF entity may derive the maximum availability time by performing blocks 408 and 410. At block 408, the AMF entity determines a time period during which the terminal device is to keep reachable after the status of the terminal device changes from unreachable to reachable. For example, the time period may be determined based on a power saving configuration of the terminal device. The power saving configuration of the terminal device may include, but not limited to, one or more of: at least one parameter about extended connected time for MICO mode; at least one parameter about active time for MICO mode; and at least one parameter about periodic registration timer control for MICO mode. At block 410, the AMF entity determines, as the maximum availability time, current time plus a length of the time period. The current time may refer to the time point at which the status of the terminal device is detected as having changed from unreachable to reachable. Thus, the determined maximum availability time may indicate an absolute time point. It is also possible that the maximum availability time may be represented in any other suitable form.

FIG. 3 is a flowchart illustrating a method implemented at an AMF entity according to another embodiment of the disclosure. At block 301, the AMF entity receives, from a second entity, a subscription request for event reporting about reachability of a terminal device. For example, the second entity may be a UDM entity or an SMF entity. The subscription request may contain the identifier of the terminal device and also indicate a destination entity to which the report is to be sent. At block 202, the AMF entity detects a status of the terminal device changing from unreachable to reachable. At block 204, the AMF entity sends, to a first entity, a report indicating that the terminal device is reachable. The report contains a maximum availability time until which the terminal device is expected to be reachable. As described above, the first entity may be the destination entity indicated in the subscription request. Alternatively, the first entity may be another entity receiving the report indirectly via the destination entity. Other details about blocks 202-204 have been described above and thus are omitted here.

FIG. 5 is a flowchart illustrating a method implemented at a UDM entity according to an embodiment of the disclosure. At block 502, the UDM entity receives, from an AMF entity, a first report indicating that a terminal device is reachable. The first report contains a maximum availability time until which the terminal device is expected to be reachable. Block 502 corresponds to block 204. At block 504, the UDM entity sends, to a third entity, a second report indicating that the terminal device is reachable. The second report contains the maximum availability time. In this way, it is possible for a service consumer to use the reported maximum availability time to schedule a message delivery to the terminal device.

As an example, the third entity may be an SMS entity (e.g. SMS interworking mobile services switching center simply referred to as SMS-IWMSC) or an NEF entity. In this case, the second report may be directly sent to the SMS entity or the NEF entity. Other examples of the third entity may include, but not limited to, an AF entity, another SMS entity (e.g. SMS-SC), an SCS entity and an AS entity. In this case, the second report may be sent to such entity indirectly via the SMS entity or the NEF entity.

FIG. 6 is a flowchart illustrating a method implemented at a UDM entity according to another embodiment of the disclosure. At block 601, the UDM entity sends, to the AMF entity, a first subscription request for event reporting about reachability of a terminal device, in response to a trigger event indicating that event reporting about reachability of the terminal device is required by a third entity. As an example, the trigger event may be receiving, from an SMS-GMSC, a message indicating that an SMS delivery for the terminal device fails, which means the SMS-SC requires the event reporting. As another example, the trigger event may be receiving, from an NEF entity, a second subscription request for event reporting about reachability of the terminal device. At block 502, the UDM entity receives, from the AMF entity, a first report indicating that a terminal device is reachable. The first report contains a maximum availability time until which the terminal device is expected to be reachable. At block 504, the UDM entity sends, to a third entity, a second report indicating that the terminal device is reachable. The second report contains the maximum availability time.

FIG. 7 is a flowchart illustrating a method implemented at an NEF entity according to an embodiment of the disclosure. At block 702, the NEF entity receives, from a UDM entity or an AMF entity, a first report indicating that a terminal device is reachable. The first report contains a maximum availability time until which the terminal device is expected to be reachable. Block 702 corresponds to block 202 or 504. At block 704, the UDM entity sends, to a fourth entity, a second report indicating that the terminal device is reachable. The second report contains the maximum availability time. Examples of the fourth entity may include, but not limited to, an AF entity, an SCS entity and an AS entity. With the method of FIG. 7, it is possible for a service consumer to use the reported maximum availability time to schedule a message delivery to the terminal device.

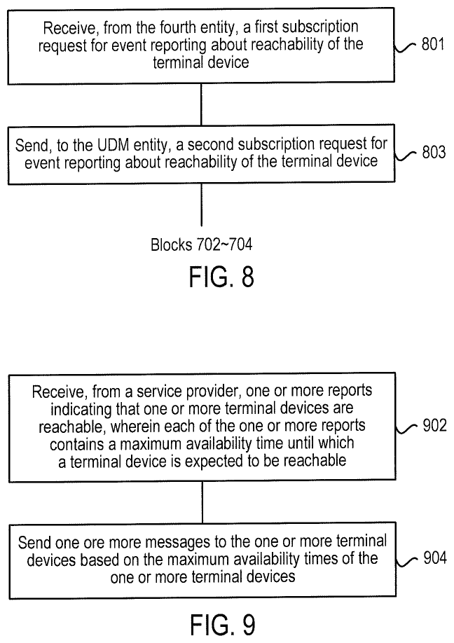

FIG. 8 is a flowchart illustrating a method implemented at an NEF entity according to another embodiment of the disclosure. At block 801, the NEF entity receives, from a fourth entity, a first subscription request for event reporting about reachability of a terminal device. Examples of the fourth entity may include, but not limited to, an AF entity, an SCS entity and an AS entity. At block 803, the NEF entity sends, to the UDM entity, a second subscription request for event reporting about reachability of the terminal device. At block 702, the NEF entity receives, from the UDM entity or an AMF entity, a first report indicating that a terminal device is reachable. The first report contains a maximum availability time until which the terminal device is expected to be reachable. At block 704, the UDM entity sends, to the fourth entity, a second report indicating that the terminal device is reachable. The second report contains the maximum availability time.

FIG. 9 is a flowchart illustrating a method implemented at a service consumer according to an embodiment of the disclosure. Examples of the service consumer may include, but not limited to, an SMS entity (e.g. SMS-SC), an AF entity, an SCS entity, an AS entity, an NEF entity, an SMF entity and a UPF entity. For example, the NEF entity may act as a service consumer on behalf of the AF entity or the SCS/AS entity. The SMF entity may subscribe to an event reporting from an AMF entity. The UPF entity may subscribe to an event reporting from the SMF entity. At block 902, the service consumer receives, from a service provider, one or more reports indicating that one or more terminal devices are reachable. Each of the one or more reports contains a maximum availability time until which a terminal device is expected to be reachable. Examples of the service provider may include, but not limited to, a UDM entity, an NEF entity, an AMF entity and an SMF entity. Depending on the number of reports received during a predetermined time period, there may be two cases. In the first case, during the predetermined time period, the service consumer receives one report indicating that one terminal device is reachable. This report contains a maximum availability time of the terminal device. In the second case, during the predetermined time period, the service consumer receives a plurality of reports indicating that a plurality of terminal devices are reachable. Each of the reports contains a maximum availability time of a corresponding terminal device.

At block 904, the service consumer sends one or more messages to the one or more terminal devices based on the maximum availability times of the one or more terminal devices. For example, the one or more messages may be SMS messages or may be used for non-IP data delivery (NIDD). In the above first case, since the maximum availability time of the terminal device is known, as long as the time permits, the service consumer may send one or more messages to the terminal device as needed. In the above second case, the service consumer may send a plurality of messages to the plurality of terminal devices by ordering the messages based on the maximum availability times of the plurality of terminal devices. For example, the messages may be ordered in an ascending order of the maximum availability times of the plurality of terminal devices. Accordingly, the messages may be sent to the plurality of terminal devices in the ascending order of the maximum availability times.

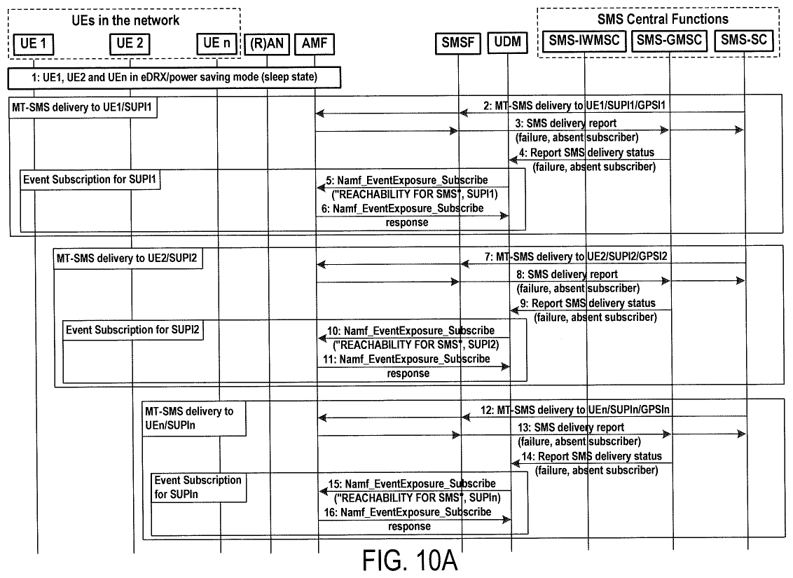

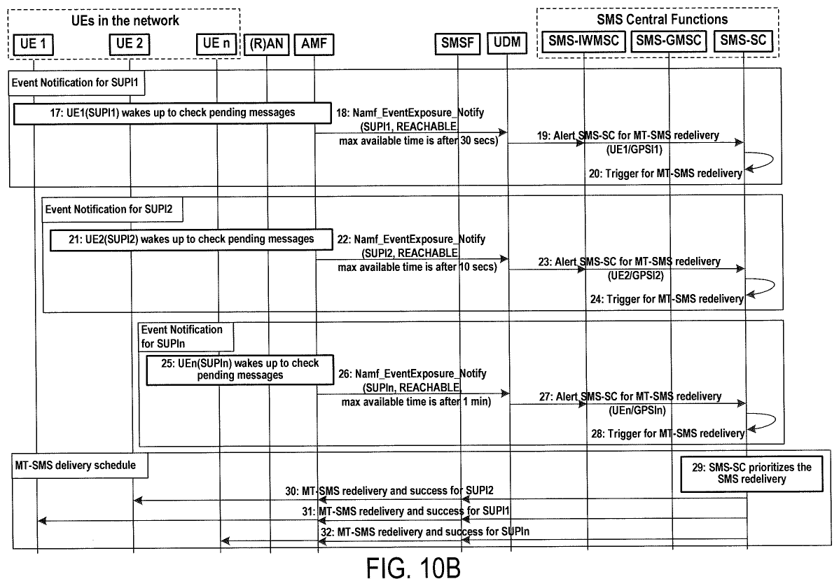

FIGS. 10A-10B are flowcharts illustrating an exemplary process according to an embodiment of the disclosure. The process relates to MT-SMS delivery and is applicable to UEs working in the power saving enhancements as described hereinbefore, in power saving mode (PSM). As shown, the process involves a plurality of UEs (e.g. UE1, UE2, . . . , UEn), a (R)AN, an AMF, an SMS function (SMSF), a UDM, an SMS-IWMSC, an SMS-GMSC and an SMS-SC. It is assumed that when the SMS-SC tries to deliver MT-SMS to users but the UEs by coincidence are in sleep state.

At step 1, a plurality of UEs, especially cellular IoT based, are working in power saving enhanced modes, for example, PSM mode. Suppose at this point, a series of UEs, UE1, UE2, . . . , UEn are in sleep state. Their subscription permanent identifiers (SUPIs) and generic public subscriber identifier (GPSIs) are denoted as SUPI1, SUPI2, . . . , SUPn and GPSI1, GPSI2, . . . , GPSIn respectively.

At step 2, a short message needs to be delivered to UE1 as the receiver. The SMS-SC initiates the MT-SMS delivery procedure to deliver the short message to UE1 through the SMSF and the AMF by SMS over 5G NAS. At step 3, the AMF detects that UE1 is sleeping, so a SMS delivery report is sent back to the SMS-SC through the SMSF and the SMS-GMSC, with a failure indication of failed SMS delivery and the failure reason is absent subscriber. At step 4, upon the receipt of the SMS delivery report with the failure and failure reason indication, the SMS-GMSC also reports the SMS delivery status to the UDM, with failure indication and the failure reason is absent subscriber.

At step 5, the UDM subscribes the UE reachability for SMS event report from the AMF through Namf_EventExposure_Subscribe request. The UE identity is also contained in the message, i.e. SUPI of UE1, denoted as SUPI1 in the figure. At step 6, the AMF accepts the event subscription request and responds to the UDM.

Steps 7-11 describe below are a repeating procedure of steps 2-6 but are for MT-SMS delivery to UE2/SUPI2. At step 7, a short message needs to be delivered to UE2 as the receiver. The SMS-SC initiates the MT-SMS delivery procedure to deliver the short message to UE2 through the SMSF and the AMF by SMS over 5G NAS. At step 8, the AMF detects that UE2 is sleeping, so a SMS delivery report is sent back to the SMS-SC through the SMSF and the SMS-GMSC, with a failure indication of failed SMS delivery and the reason is absent subscriber. At step 9, upon the receipt of the SMS delivery report with the failure and failure reason indication, the SMS-GMSC also reports the SMS delivery status to the UDM, with failure indication and the reason is absent subscriber. At step 10, the UDM subscribes the UE reachability for SMS event report from the AMF through Namf_EventExposure_Subscribe request. The UE identity is also contained in the message, i.e. SUPI of UE2, denoted as SUPI2 in the figure. At step 11, the AMF accepts the event subscription request and responds to the UDM.

Steps 12-16 describe below are a repeating procedure of steps 2-6 but are for MT-SMS delivery to UEn/SUPIn. At step 12, a short message needs to be delivered to UEn as the receiver. The SMS-SC initiates the MT-SMS delivery procedure to deliver the short message to UEn through the SMSF and the AMF by SMS over 5G NAS. At step 13, the AMF detects that UEn is sleeping, so a SMS deliver report is sent back to the SMS-SC through the SMSF and the SMS-GMSC, with a failure indication of failed SMS delivery and the failure reason is absent subscriber. At step 14, upon the receipt of the SMS delivery report with the failure and failure reason indication, the SMS-GMSC also reports the SMS delivery status to the UDM, with failure indication and the failure reason is absent subscriber. At step 15, the UDM subscribes the UE reachability for SMS event report from the AMF through Namf_EventExposure_Subscribe request. The UE identity is also contained in the message, i.e. SUPI of UEn, denoted as SUPIn in the figure. At step 16, the AMF accepts the event subscription request and responds to the UDM.

At step 17, UE1 wakes up from sleeping and contacts the network for pending messages. At step 18, the AMF notifies the UDM by the Namf_EventExposure_Notify interface that UE1 is reachable for SMS, and with the max availability time until that time point UE will keep active, for example after 30 seconds. In order to provide the max availability time, standardization update may be needed for the event reporting with max UE availability time. Table 1 below shows the updated message exchanged between the AMF and the UDM in order to provide the max availability time.

TABLE 1
Definition of type AmfEventReport (updates compared to Table 6.2.6.2.5-1 of TS 29.518 is underlined)

| Attribute name | Data type | P | Cardinality | Description |
|---|---|---|---|---|
| type | AmfEventType | M | 1 | Describes the type of the event which triggers |
| | | | | the report |
| state | AmfEventState | M | 1 | Describes the state of the event which triggered |
| | | | | the report. This IE shall be set to “TRUE” when |
| | | | | subscriptionId IE is present. |
| timeStamp | DateTime | M | 1 | This IE shall contain the time at which the event |
| | | | | is generated. |
| subscriptionId | Uri | C | 0 . . . 1 | This IE shall be included when the event |
| | | | | notification is for informing the creation of a |
| | | | | subscription Id at the AMF during mobility of a |
| | | | | UE across AMFs. |
| | | | | When present, this IE shall contain the URI of |
| | | | | the created subscription resource at the AMF. |
| | | | | The type IE shall be set to: |
| | | | | SUBSCRIPTION_ID_CHANGE, when |
| | | | | the AMFcreates a subscription Id for a UE |
| | | | | specific event subscription during mobility |
| | | | | registration and handover procedures |
| | | | | involving an AMF change. |
| | | | | SUBSCRIPTION_ID_ADDITION, when |
| | | | | the AMF creates a subscription Id for a group |
| | | | | Id specific event subscription during mobility |
| | | | | registration and handover procedures |
| | | | | involving an AMF change. |
| anyUe | boolean | C | 0 . . . 1 | This IE shall be included and shall be set to |
| | | | | “true”, if the event subscription is a bulk |
| | | | | subscription for number of UEs and the event |
| | | | | reported is for one of those UEs. |
| supi | Supi | C | 0 . . . 1 | This IE shall be present if available. |
| | | | | When present, this IE identifies the SUPI of the |
| | | | | UE associated with the report (NOTE). |
| areaList | array(AmfEventArea) | C | 1 . . . N | This IE shall be present when the AMF event |
| | | | | type is “PRESENCE_IN_AOI_REPORT”. When |
| | | | | present, this IE represents the specified Area(s) |
| | | | | of Interest the UE is currently IN/OUT/UNKNOWN. |
| refId | ReferenceId | C | 0 . . . 1 | This IE shall be present if a Reference Id has |
| | | | | previously been associated with the event |
| | | | | triggering the report. |
| | | | | When present, this IE shall indicate the |
| | | | | Reference Id associated with the event which |
| | | | | triggers the report. |
| gpsi | Gpsi | C | 0 . . . 1 | This IE shall be present if available. |
| | | | | When present, this IE identifies the GPSI of the |
| | | | | UE associated with the report (NOTE). |
| pei | Pei | O | 0 . . . 1 | This IE may be included if the event reported is |
| | | | | for a particular UE or any UE. This IE identifies |
| | | | | the PEI of the UE associated with the report |
| | | | | (NOTE). |
| location | UserLocation | O | 0 . . . 1 | Represents the location information of the UE |
| timezone | TimeZone | O | 0 . . . 1 | Describes the time zone of the UE |
| accessTypeList | array(AccessType) | O | 1 . . . N | Describes the access type(s) of the UE |
| rmInfoList | array(RmInfo) | O | 1 . . . N | Describes the registration management state of |
| | | | | the UE |
| cmInfoList | array(CmInfo) | O | 1 . . . N | Describes the connectivity state of the UE |
| reachability | UeReachability | O | 0 . . . 1 | Describes the reachability of the UE |
| maxAvail- | DateTime | O | 0 . . . 1 | Indicates the time (in UTC) until which the UE is |
| abilityTime | | | | expected to be reachable. |
| | | | | Only could be present for |
| | | | | REACHABILITYREPORT and UeReachability |
| | | | | is REACHABLE. |
| | | | | This IE may be used by the SMS Center to |
| | | | | prioritize the retransmission of Short Message to |
| | | | | UEs using a power saving mechanism. |
| commFailure | CommunicationFailure | O | 0 . . . 1 | Describes a communication failure for the UE. |
| numberOfUes | integer | O | 0 . . . 1 | Represents the number of UEs in the specified |
| | | | | area |
| 5gsUserStateList | array(5GsUserStateInfo) | O | 1 . . . N | Represents the 5GS User State of the UE per |
| | | | | access type |

NOTE:
If the event report corresponds to an event subscription of a single UE, then the same UE identifier (i.e. SUPI and/or GPSI and/or PEI) received during subscription creation shall be included in the report. If the event report corresponds to an event subscription for group of UEs or any UE, then the SUPI and if available the GPSI shall be included in the event report. SUPI, PEI and GPSI shall not be present in report for UES_IN_AREA_REPORT event type.

At step 19, when receiving the reachability notification from the AMF, the UDM alerts the SMS-SC to deliver the pending SMS also with the max UE availability time. At step 20, the SMS-SC triggers the MT-SMS delivery. As the max UE availability time is available, the SMS-SC could have enhanced schedule mechanism, for example hold a bit of time instead of delivering it immediately.

At step 21, UE2 wakes up from sleeping and contacts the network for pending messages. At step 22, the AMF notifies the UDM by the Namf_EventExposure_Notify interface that UE2 is reachable for SMS, and also with the max availability time until that time point UE will keep active, for example after 10 seconds. The update as described in step 18 is used to provide the max availability time in the event report. At step 23, when receiving the reachability notification from the AMF, the UDM alerts the SMS-SC to deliver the pending SMS also with the max availability time. At step 24, the SMS-SC triggers the MT-SMS redelivery. As the max availability time is available, the SMS-SC could have enhanced schedule mechanism, for example hold a bit of time instead of delivering it immediately.

At step 25, UEn wakes up from sleeping and contacts the network for pending messages. At step 26, the AMF notifies the UDM by the Namf_EventExposure_Notify interface that UEn is reachable for SMS, and with the max UE availability time until that time point UE will keep active, for example after 1 minute. The update as described in step 18 is used to provide the max availability time in the event report. At step 27, when receiving the reachability notification from the AMF, the UDM alerts the SMS-SC to deliver the pending SMS also with the max availability time. At step 28, the SMS-SC triggers the MT-SMS redelivery. As the max availability time is available, the SMS-SC could have enhanced schedule mechanism, for example hold a bit of time instead of delivering it immediately.

At step 29, the SMS-SC based on the max availability time to prioritize the delivery of the SMS in the order of UE availability time to be expired. For example, suppose the alert messages were received almost the same time. Then, MT-SMS to UE2 is prioritized over MT-SMS to UE1 as UE2 will keep wakeup for a shorter time period than UE1. Similarly, MT-SMS to UE1 is prioritized over MT-SMS to UEn as UE1 will keep wakeup for a shorter time period than UEn. At step 30, MT-SMS deliver to UE2 succeeds. At step 31, MT-SMS deliver to UE1 succeeds. At step 32, MT-SMS deliver to UEn succeeds.

Steps 29-32 show the optimized MT-SMS delivery schedule to ensure the message deliver efficiency. Without the update described above, the SMS-SC cannot prioritize the MT-SMS delivery based on the max availability time. It is more prone that MT-SMS to UE2 could be failed again if UE2 enter into sleep mode again before the SMS-SC schedules the SMS delivery to UE2.

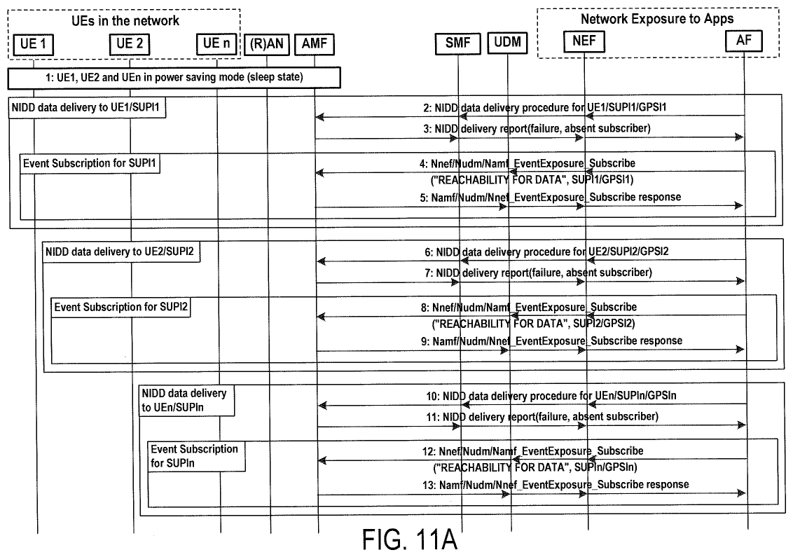

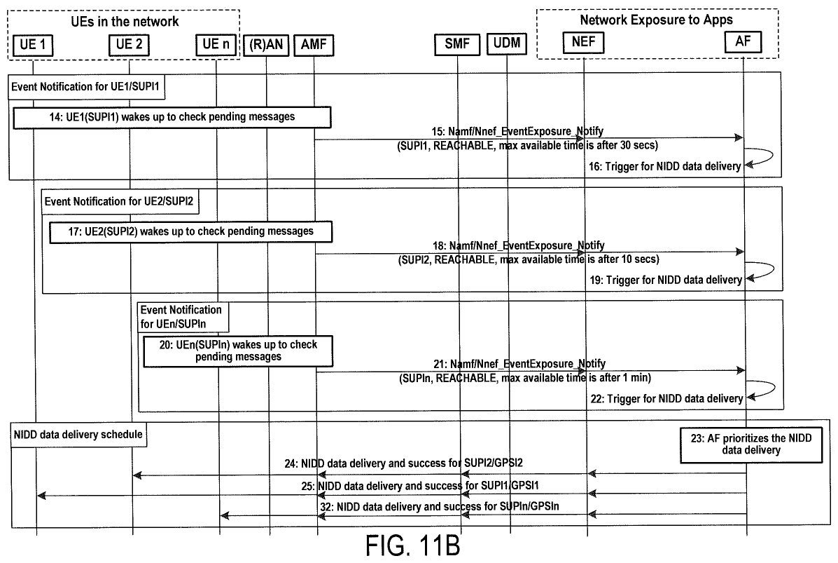

FIGS. 11A-11B are flowcharts illustrating an exemplary process according to an embodiment of the disclosure. The process relates to NIDD data delivery and is applicable to UEs working in the power saving enhancements as described hereinbefore, in PSM mode. As shown, the process involves a plurality of UEs (e.g. UE1, UE2, . . . , UEn), a (R)AN, an AMF, an SMF, a UDM, an NEF and an AF. It is assumed that when the AF tries to deliver NIDD data to users but the UEs by coincidence are in sleep mode.

At step 1, a plurality of UEs, especially cellular IoT based, are working in power saving enhanced modes, for example, PSM mode. Suppose at this point, a series of UEs, UE1, UE2, . . . , UEn are in sleep state. Their SUPIs and GPSIs are denoted as SUPI1, SUPI2, . . . , SUPn and GPSI1, GPSI2, . . . , GPSIn respectively.

At step 2, an application service that UE1 has subscribed has NIDD data to be delivered to UE1 as the receiver. The AF triggers the NIDD data delivery procedure to UE1 through the NEF, the SMF and the AMF by control plane (CP) optimized IoT NIDD data delivery. At step 3, the AMF detects that UE1 is in sleep mode and unreachable for data delivery and a failure report is sent back to the AF through the SMF and the NEF, with a failure indication of failed NIDD data delivery and the failure reason is absent subscriber.

At step 4, upon the receipt of the NIDD data delivery report with the failure indication and failure reason indication of absent subscriber, the AF subscribes the UE reachability for DATA event report from the NEF through Nudm_EventExposure_Subscribe request. The UE identity is also contained in the message, i.e. SUPI/GPSI of UE1, denoted as SUPI1/GPSI1 in the figure. The NEF subscribes the UE reachability for DATA report from the UDM through Nudm_EventExposure_Subscribe request. The UE identity is also contained in the message, i.e. SUPI/GPSI of UE1, denoted as SUPI1/GPSI1 in the figure. The UDM subscribes the UE reachability for DATA report from the AMF through Namf_EventExposure_Subscribe request. The UE identity is also contained in the message, i.e. SUPI/GPSI of UE1, denoted as SUPI1/GPSI1 in the figure. At step 5, the AMF/UDM/NEF accepts the event subscription request and responds to UDM/NEF/AF correspondingly.

Steps 6-9 described below are a repeating procedure of steps 2-5 but are for NIDD data delivery to UE2. At step 6, an application service that UE2 has subscribed has NIDD data to be delivered to UE2 as the receiver. The AF triggers the NIDD data delivery procedure to UE2 through the NEF, the SMF and the AMF by CP optimized IoT NIDD data delivery. At step 7, the AMF detects that UE2 is in sleep mode and unreachable for data delivery and a failure report is sent back to the AF through the SMF and the NEF, with a failure indication of failed NIDD data delivery and the failure reason is absent subscriber.

At step 8, upon the receipt of the NIDD data delivery report with the failure indication and failure reason indication of absent subscriber, the AF subscribes the UE reachability for DATA event report from the NEF through Nudm_EventExposure_Subscribe request. The UE identity is also contained in the message, i.e. SUPI/GPSI of UE2, denoted as SUPI2/GPSI2 in the figure. The NEF subscribes the UE reachability for DATA event report from the UDM through Nudm_EventExposure_Subscribe request. The UE identity is also contained in the message, i.e. SUPI/GPSI of UE2, denoted as SUPI2/GPSI2 in the figure. The UDM subscribes the UE reachability for DATA report from the AMF through Namf_EventExposure_Subscribe request. The UE identity is also contained in the message, i.e. SUPI/GPSI of UE2, denoted as SUPI2/GPSI2 in the figure. At step 9, the AMF/UDM/NEF accepts the event subscription request and responds to the UDM/NEF/AF correspondingly.

Steps 10-13 described below are a repeating procedure of steps 2-5 but are for NIDD data delivery to UEn. At step 10, an application service that UEn has subscribed has NIDD data to be delivered to UEn as the receiver. The AF triggers the NIDD data delivery procedure to UEn through the NEF, the SMF and the AMF by CP optimized IoT NIDD data delivery. At step 11, the AMF detects that UEn is in sleep mode and unreachable for data delivery and a failure report is sent back to the AF through the SMF and the NEF, with a failure indication of failed NIDD data delivery and the failure reason is absent subscriber.

At step 12, upon the receipt of the NIDD data delivery report with the failure indication and failure reason indication of absent subscriber, the AF subscribes the UE reachability for DATA event report from the NEF through Nudm_EventExposure Subscribe request. The UE identity is also contained in the message, i.e. SUPI/GPSI of UEn, denoted as SUPIn/GPSIn in the figure. The NEF subscribes the UE reachability for DATA event report from the UDM through Nudm_EventExposure_Subscribe request. The UE identity is also contained in the message, i.e. SUPI/GPSI of UEn, denoted as SUPIn/GPSIn in the figure. The UDM subscribes the UE reachability for DATA report from the AMF through Namf_EventExposure Subscribe request. The UE identity is also contained in the message, i.e. SUPI/GPSI of UEn, denoted as SUPIn/GPSIn in the figure. At step 13, the AMF/UDM/NEF accepts the event subscription request and responds to the UDM/NEF/AF correspondingly.

At step 14, UE1 wakes up from sleeping and contacts the network for pending messages. At step 15, the AMF notifies the NEF by the Namf_EventExposure_Notify interface and the NEF notifies the AF by the Nnef_EventExposure_Notify interface that UE1 is reachable for DATA, and with the max availability time until that time point UE will keep active, for example after 30 seconds. The update described in step 18 of FIG. 10B is used to provide the max availability time in the event report from the AMF to the NEF. At step 16, the AF triggers the NIDD data delivery. As the max availability time is available, the AF could have enhanced schedule mechanism, for example hold a bit of time instead of delivering it immediately.

At step 17, UE2 wakes up from sleeping and contacts the network for pending messages. At step 18, the AMF notifies the NEF by the Namf_EventExposure_Notify interface, and the NEF notifies the AF by the Nnef_EventExposure_Notify interface that UE2 is reachable for DATA, and with the max availability time until that time point UE will keep active, for example after 10 seconds. The update described in step 18 of FIG. 10B is used to provide the max availability time in the event report from the AMF to the NEF. At step 19, the AF triggers the NIDD data delivery. As the max availability time is available, the AF could have enhanced schedule mechanism, for example hold a bit of time instead of delivering it immediately.

At step 20, UEn wakes up from sleeping and contacts the network for pending messages. At step 21, the AMF notifies the NEF by the Namf_EventExposure_Notify interface, and NEF notifies the AF by the Nnef_EventExposure_Notify interface that UEn is reachable for DATA, and with the max availability time until that time point UE will keep active, for example after 1 minute. The update described in step 18 of FIG. 10B is used to provide the max availability time in the event report from the AMF to the NEF. At step 22, the AF triggers the NIDD data delivery. As the max availability time is available, the AF could have enhanced schedule mechanism, for example hold a bit of time instead of delivering it immediately.

At step 23, the AF based on the max UE availability time to prioritize the delivery of the data in the order of the availability time to be expired. For example, suppose the reachability for data event reports were received almost the same time. Then, NIDD data to UE2 is prioritized over NIDD data to UE1 as UE2 will keep wakeup for a shorter time period than UE1. Similarly, NIDD data to UE1 is prioritized over NIDD data to UEn as UE1 will keep wakeup for a shorter time period than UEn. At step 24, NIDD data deliver to UE2 succeeds. At step 25, NIDD data deliver to UE1 succeeds. At step 26, NIDD data deliver to UEn succeeds.

Steps 23-26 show the optimized NIDD data delivery schedule to ensure the data deliver efficiency. Without the update described above, the AF cannot prioritize the NIDD data delivery based on the max availability time. It is more prone that NIDD data delivery to UE2 could be failed again if UE2 enters into sleep mode again before the AF schedules the NIDD data delivery to UE2.

In the above process, for high latency data communication, the AF (or UPF or SMF or NEF) prioritizes and optimizes the transmission of pending message or data to UEs using a power saving mechanism. Since UEs are known to have Maximum UE Availability Time, such parameter could be used as input to optimize the schedule mechanism at the service entities.

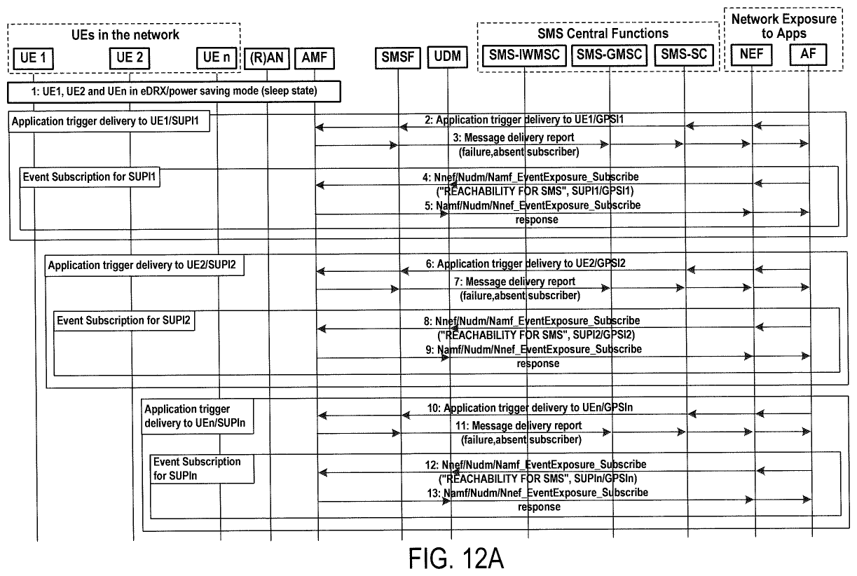

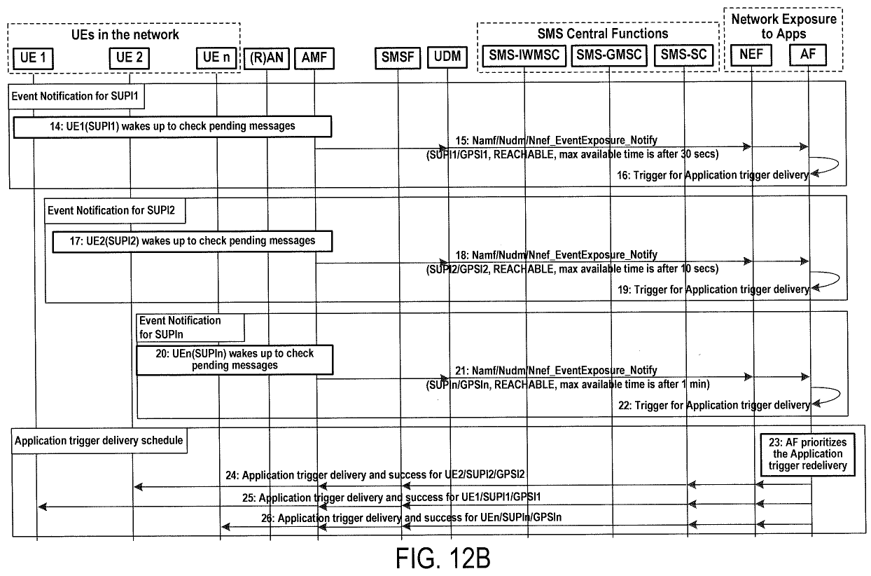

FIGS. 12A-12B are flowcharts illustrating an exemplary process according to an embodiment of the disclosure. The process relates to application trigger delivery and is applicable to UEs working in the power saving enhancements as described hereinbefore, in PSM mode. As shown, the process involves a plurality of UEs (e.g. UE1, UE2, . . . , UEn), a (R)AN, an AMF, an SMSF, a UDM, an SMS-IWMSC, an SMS-GMSC, an SMS-SC, an NEF and an AF. It is assumed that when the AF tries to deliver application trigger to users but the UEs by coincidence are in sleep mode.

At step 1, a plurality of UEs, especially cellular IoT based, are working in power saving enhanced modes, for example, PSM mode. Suppose at this point, a series of UEs, UE1, UE2, . . . , UEn are in sleep state. Their SUPIs and GPSIs are denoted as SUPI1, SUPI2, . . . , SUPn and GPSI1, GPSI2, . . . , GPSIn respectively.

At step 2, an application service that UE has been subscribed has an application trigger message to be delivered to UE1 as the receiver. The AF triggers the application trigger delivery procedure to UE1 through the NEF, the SMS-SC and the AMF by SMS over NAS. At step 3, the AMF detects that UE1 is in sleep mode and unreachable for message delivery and a failure report is sent back to the AF through the SMS-SC and the NEF, with a failure indication of failed application trigger delivery and the failure reason is absent subscriber.

At step 4, upon the receipt of the message delivery report with the failure indication and failure reason indication of absent subscriber, the AF subscribes the UE reachability for SMSevent report from the NEF through Nudm_EventExposure_Subscribe request. The UE identity is also contained in the message, i.e. SUPI/GPSI of UE1, denoted as SUPI1/GPSI1 in the figure. The NEF subscribes the UE reachability for SMSevent report from the UDM through Nudm_EventExposure_Subscribe request. The UE identity is also contained in the message, i.e. SUPI/GPSI of UE1, denoted as SUPI1/GPSI1 in the figure. The UDM subscribes the UE reachability for SMS event report from the AMF through Namf_EventExposure_Subscribe request. The UE identity is also contained in the message, i.e. SUPI/GPSI of UE1, denoted as SUPI1/GPSI1 in the figure. At step 5, the AMF/UDM/NEF accepts the event subscription request and responds to the UDM/NEF/AF correspondingly.

Steps 6-9 described below are a repeating procedure of steps 2-5 but are for application trigger delivery to UE2. At step 6, an application service that UE2 has subscribed has an application trigger message to be delivered to UE2 as the receiver. The AF triggers the application trigger delivery procedure to UE2 through the NEF, the SMS-SC and the AMF by SMS over NAS. At step 7, the AMF detects that UE2 is in sleep mode and unreachable for data delivery and a failure report is sent back to the AF through the SMS-SC and the NEF, with a failure indication of failed application trigger delivery and the failure reason is absent subscriber.

At step 8, upon the receipt of the message delivery report with the failure indication and failure reason indication of absent subscriber, the AF subscribes the UE reachability for SMSevent report from the NEF through Nudm_EventExposure_Subscribe request. The UE identity is also contained in the message, i.e. SUPI/GPSI of UE2, denoted as SUPI2/GPSI2 in the figure. The NEF subscribes the UE reachability for SMSevent report from the UDM through Nudm_EventExposure_Subscribe request. The UE identity is also contained in the message, i.e. SUPI/GPSI of UE2, denoted as SUPI2/GPSI2 in the figure. The UDM subscribes the UE reachability for SMSevent report from the AMF through Namf_EventExposure_Subscribe request. The UE identity is also contained in the message, i.e. SUPI/GPSI of UE2, denoted as SUPI2/GPSI2 in the figure. At step 9, the AMF/UDM/NEF accepts the event subscription request and responds to the UDM/NEF/AF correspondingly.

Steps 10-13 described below are a repeating procedure of steps 2-5 but are for application trigger delivery to UEn. At step 10, an application service that UEn has subscribed has an application trigger message to be delivered to UEn as the receiver. The AF triggers the application trigger delivery procedure to UEn through the NEF, the SMS-SC and the AMF by SMS over NAS. At step 11, the AMF detects that UEn is in sleep mode and unreachable for data delivery and a failure report is sent back to the AF through the SMS-SC and the NEF, with a failure indication of failed application trigger delivery and the failure reason is absent subscriber.

At step 12, upon the receipt of the message delivery report with the failure indication and failure reason indication of absent subscriber, the AF subscribes the UE reachability for SMS report from the NEF through Nudm_EventExposure_Subscribe request. The UE identity is also contained in the message, i.e. SUPI/GPSI of UEn, denoted as SUPIn/GPSIn in the figure. The NEF subscribes the UE reachability for SMS report from the UDM through Nudm_EventExposure_Subscribe request. The UE identity is also contained in the message, i.e. SUPI/GPSI of UEn, denoted as SUPIn/GPSIn in the figure. The UDM subscribes the UE reachability for SMS report from the AMF through Namf_EventExposure_Subscribe request. The UE identity is also contained in the message, i.e. SUPI/GPSI of UEn, denoted as SUPIn/GPSIn in the figure. At step 13, the AMF/UDM/NEF accepts the event subscription request and responds to UDM/NEF/AF correspondingly.

At step 14, UE1 wakes up from sleeping and contacts the network for pending messages. At step 15, the AMF notifies the UDM by the Namf_EventExposure_Notify interface, the UDM notifies the NEF by the Nudm_EventExposure_Notify interface, and the NEF notifies the AF by the Nnef_EventExposure_Notify interface that UE1 is reachable for SMS, and with the max availability time until that time point UE will keep active, for example after 30 seconds. The update described in step 18 of FIG. 10B is used to provide the max availability time in the event report from the AMF to the NEF.

Table 2 shows an alternative update for the event report from the UDM to the NEF to provide the max UE availability time.

TABLE 2
Definition of type ReachabilityForSmsReport (updates compared
to Table 6.4.6.2.12-1 of TS 29.503 are underlined)

| Attribute name | Data type | P | Cardinality | Description |
|---|---|---|---|---|
| smsfAccessType | AccessType | M | 1 | |
| maxAvail- | DateTime | O | 0 . . . 1 | The maximum availability |
| abilityTime | | | | time (in UTC)until which |
| | | | | a UE using a power saving |
| | | | | mechanism (such as extended |
| | | | | idle mode DRX) is expected |
| | | | | to be reachable |
| | | | | ThisIE may be included to |
| | | | | identify the timestamp until |
| | | | | which a UE using a power |
| | | | | saving mechanism is expected |
| | | | | to be reachable for SM |
| | | | | delivery. |

Table 3 below shows another alternative update for the UDM to provide the max UE availability time to the NEF.

TABLE 3
Definition of type MonitoringReport (updates compared to Table 6.4.6.2.4-1 of TS 29.503 are underlined)

| Attribute name | Data type | P | Cardinality | Description |
|---|---|---|---|---|
| referenceId | ReferenceId | M | 1 | |
| eventType | EventType | M | 1 | String; see clause 6.4.6.3.3 |
| | | | | only the following values are allowed: |
| | | | | “UE_REACHABILITY_FOR_SMS” |
| | | | | “CHANGE_OF_SUPI_PEI_ASSOCIATION” |
| | | | | “ROAMING_STATUS” |
| | | | | “CN_TYPE_CHANGE” |
| report | Report | C | 0 . . . 1 | Shall be present if eventType is |
| | | | | “CHANGE_OF_SUPI_PEI_ASSOCIATION” |
| | | | | or “ROAMING_STATUS” |
| | | | | “CN_TYPE_CHANGE” |
| reachabilityForSmsReport | ReachabilityFor | C | 0 . . . 1 | Should be present if eventType is |
| | SmsReport | | | “UE_REACHABILITY_FOR_SMS” |
| maxAvail- | Datetime | O | 0 . . . 1 | The maximum availability time (in UTC)until |
| abilityTime | | | | which a UE using a power saving mechanism |
| | | | | (such as extended idle mode DRX) is |
| | | | | expected to be reachable |
| | | | | If “event-Type” is |
| | | | | “UE REACHABILITY FOR SMS”, this IE |
| | | | | may be included to identify the timestamp |
| | | | | until which a UE using a power saving |
| | | | | mechanism is expected to be reachable for |
| | | | | SM delivery. |
| gpsi | Gpsi | C | 0 . . . 1 | shall be present if the report is associated to |
| | | | | exposure subscriptions for a group of UEs or any |
| | | | | UE. |
| timeStamp | DateTime | M | 1 | Point in time at which the event occured |

At step 16, the AF triggers the NIDD data delivery. As the max availability time is available, the AF could have enhanced schedule mechanism, for example hold a bit of time instead of delivering it immediately. At step 17, UE2 wakes up from sleeping and contacts the network for pending messages. At step 18, the AMF notifies the UDM by the Namf_EventExposure_Notify interface, the UDM notifies the NEF by the Nudm_EventExposure_Notify interface, and the NEF notifies the AF by the Nnef_EventExposure_Notify interface that UE2 is reachable for DATA, and with the max availability time until that time point UE will keep active, for example after 10 seconds. The update described in step 18 of FIG. 10B is used to provide the max availability time in the event report from the AMF to the UDM. Alternatively, the update described in step 15 of FIG. 12B is used to provide the max availability time in the event report from the UDM to the NEF. At step 19, the AF triggers the NIDD data delivery. As the max availability time is available, the AF could have enhanced schedule mechanism, for example hold a bit of time instead of delivering it immediately.

At step 20, UEn wakes up from sleeping and contacts the network for pending messages. At step 21, the AMF notifies the UDM by the Namf_EventExposure_Notify interface, the UDM notifies the NEF by the Nudm_EventExposure_Notifyinterface, and the NEF notifies the AF by the Nnef_EventExposure_Notify interface that UEn is reachable for DATA, and with the max availability time until that time point UE will keep active, for example after 1 minute. The update described in step 18 of FIG. 10B is used to contain the max availability time in the event report from the AMF to the UDM. Alternatively, the update described in step 15 of FIG. 12B is used to provide the max availability time in the event report from the UDM to the NEF. At step 22, the AF triggers the NIDD data delivery. As the max availability time is available, the AF could have enhanced schedule mechanism, for example hold a bit of time instead of delivering it immediately.

At step 23, the AF based on the max availability time to prioritize the delivery of the application trigger in the order of the availability time to be expired. For example, suppose the reachability for SMS event reports were received almost the same time. Then, application trigger to UE2 is prioritized over application trigger to UE1 as UE2 will keep wakeup for a shorter time period than UE1. Similarly, application trigger to UE1 is prioritized over application trigger to UEn as UE1 will keep wakeup for a shorter time period than UEn. At step 24, application trigger deliver to UE2 succeeds. At step 25, application trigger deliver to UE1 succeeds. At step 26, application trigger deliver to UEn succeeds.

Steps 23-26 show the optimized application trigger delivery schedule to ensure the data deliver efficiency. Without the update described above, the AF cannot prioritize the application trigger delivery based on the max availability time. It is more prone that application trigger to UE2 could be failed again if UE2 enters into sleep mode again before the AF schedules the application trigger delivery to UE2.

In the above processes shown in FIGS. 10A-10B and 12A-12B, for high latency SMS communication, the SMS-SC or AF prioritizes and optimizes the transmission of pending Mobile Terminated Short Messages or Application trigger to UEs using a power saving mechanism. Since UEs are known to have Maximum UE Availability Time, such parameter could be used as input to optimize the schedule mechanism at the service entities.

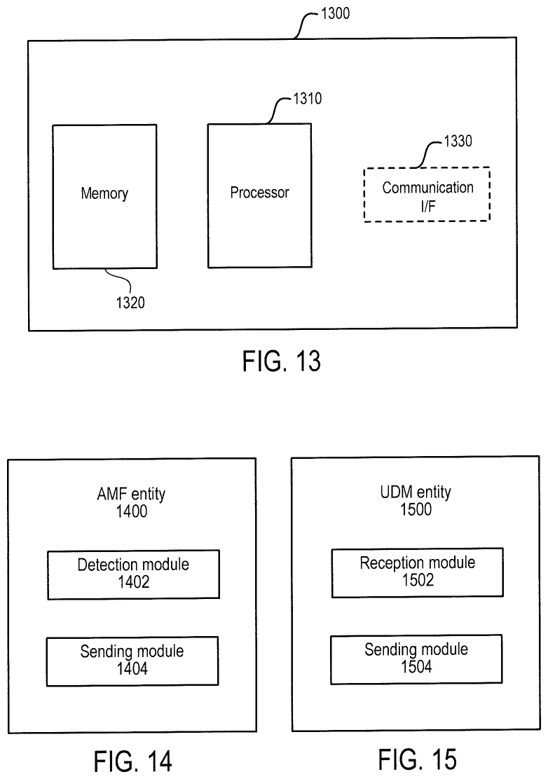

FIG. 13 is a block diagram showing an apparatus suitable for use in practicing some embodiments of the disclosure. For example, any one of the AMF entity, the UDM entity, the NEF entity and the service consumer described above may be implemented through the apparatus 1300. As shown, the apparatus 1300 may include a processor 1310, a memory 1320 that stores a program, and optionally a communication interface 1330 for communicating data with other external devices through wired and/or wireless communication.

The program includes program instructions that, when executed by the processor 1310, enable the apparatus 1300 to operate in accordance with the embodiments of the present disclosure, as discussed above. That is, the embodiments of the present disclosure may be implemented at least in part by computer software executable by the processor 1310, or by hardware, or by a combination of software and hardware.

The memory 1320 may be of any type suitable to the local technical environment and may be implemented using any suitable data storage technology, such as semiconductor based memory devices, flash memories, magnetic memory devices and systems, optical memory devices and systems, fixed memories and removable memories. The processor 1310 may be of any type suitable to the local technical environment, and may include one or more of general purpose computers, special purpose computers, microprocessors, digital signal processors (DSPs) and processors based on multi-core processor architectures, as non-limiting examples.

FIG. 14 is a block diagram showing an AMF entity according to an embodiment of the disclosure. As shown, the AMF entity 1400 comprises a detection module 1402 and a sending module 1404. The detection module 1402 may be configured to detect a status of a terminal device changing from unreachable to reachable, as described above with respect to block 202. The sending module 1404 may be configured to send, to a first entity, a report indicating that the terminal device is reachable, as described above with respect to block 204. The report may contain the maximum availability time until which the terminal device is expected to be reachable.

FIG. 15 is a block diagram showing a UDM entity according to an embodiment of the disclosure. As shown, the UDM entity 1500 comprises a reception module 1502 and a sending module 1504. The reception module 1502 may be configured to receive, from an AMF entity, a first report indicating that a terminal device is reachable, as described above with respect to block 502. The first report may contain a maximum availability time until which the terminal device is expected to be reachable. The sending module 1504 may be configured to send, to a third entity, a second report indicating that the terminal device is reachable, as described above with respect to block 504. The second report may contain the maximum availability time.

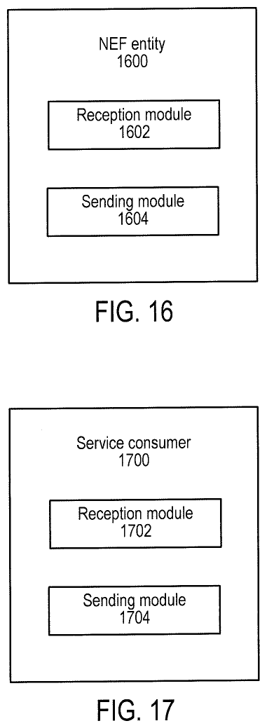

FIG. 16 is a block diagram showing an NEF entity according to an embodiment of the disclosure. As shown, the NEF entity 1600 comprises a reception module 1602 and a sending module 1604. The reception module 1602 may be configured to receive, from a UDM entity or an AMF entity, a first report indicating that a terminal device is reachable, as described above with respect to block 702. The first report may contain a maximum availability time until which the terminal device is expected to be reachable. The sending module 1604 may be configured to send, to a fourth entity, a second report indicating that the terminal device is reachable, as described above with respect to block 704. The second report may contain the maximum availability time.

FIG. 17 is a block diagram showing a service consumer according to an embodiment of the disclosure. As shown, the service consumer 1700 comprises a reception module 1702 and a sending module 1704. The reception module 1702 may be configured to receive, from a service provider, one or more reports indicating that one or more terminal devices are reachable, as described above with respect to block 902. Each of the one or more reports may contain a maximum availability time until which a terminal device is expected to be reachable. The sending module 1704 may be configured to send one or more messages to the one or more terminal devices based on the maximum availability times of the one or more terminal devices, as described above with respect to block 904. The modules described above may be implemented by hardware, or software, or a combination of both.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1-28. (canceled)

29. A method performed by a network node implementing an access and mobility management function (AMF) entity, the method comprising:
detecting a status of a terminal device changing from unreachable to reachable; and
sending, to a unified data management (UDM) entity, a report indicating that the terminal device is reachable, wherein the report contains a maximum availability time until which the terminal device is expected to be reachable,
wherein the maximum availability time is derived based on a power saving configuration of the terminal device and wherein the power saving configuration of the terminal device comprises one or more of:
at least one parameter about extended connected time for mobile initiated connection only (MICO) mode;
at least one parameter about active time for MICO mode; and
at least one parameter about periodic registration timer control for MICO mode.

30. The method of claim 29, wherein the maximum availability time indicates an absolute time point.

31. The method of claim 29, further comprising:
receiving, from a second entity, a subscription request for event reporting about reachability of the terminal device; and
wherein the report is sent based on the subscription request.

32. The method of claim 29, wherein the maximum availability time is derived by:
determining a time period during which the terminal device is to keep reachable after the status of the terminal device changes from unreachable to reachable; and
determining, as the maximum availability time, current time plus a length of the time period.

33. The method of claim 31, wherein the second entity is one of a unified data management (UDM) entity, a network exposure function (NEF) entity, a network data analytics function (NWDAF) entity, and a session management function (SMF) entity.

34. A method performed by a network node implementing a unified data management (UDM) entity, the method comprising:
receiving, from an access and mobility management function (AMF) entity, a first report indicating that a terminal device is reachable, wherein the first report contains a maximum availability time until which the terminal device is expected to be reachable; and
sending, to a network exposure function (NEF) entity, a second report indicating that the terminal device is reachable, wherein the second report contains the maximum availability time, wherein the maximum availability time is derived based on a power saving configuration of the terminal device and wherein the power saving configuration of the terminal device comprises one or more of:
at least one parameter about extended connected time for mobile initiated connection only (MICO) mode;
at least one parameter about active time for MICO mode; and
at least one parameter about periodic registration timer control for MICO mode.

35. The method of claim 34, further comprising:
sending, to the AMF entity, a first subscription request for event reporting about reachability of the terminal device, in response to a trigger event indicating that event reporting about reachability of the terminal device is required by the NEF entity.

36. The method of claim 35, wherein the trigger event is at least one of:
receiving, from a short message service gateway mobile services switching center (SMS-GMSC), a message indicating that an SMS delivery for the terminal device fails; and
receiving, from the NEF entity, a second subscription request for event reporting about reachability of the terminal device.

37. A method performed by a network node implementing a network exposure function (NEF) entity, the method comprising:
receiving, from a unified data management (UDM) entity or an access and mobility management function (AMF) entity, a first report indicating that a terminal device is reachable, wherein the first report contains a maximum availability time until which the terminal device is expected to be reachable; and
sending, to a service consumer, a second report indicating that the terminal device is reachable, wherein the second report contains the maximum availability time, wherein the maximum availability time is derived based on a power saving configuration of the terminal device and wherein the power saving configuration of the terminal device comprises one or more of:
at least one parameter about extended connected time for mobile initiated connection only (MICO) mode;
at least one parameter about active time for MICO mode; and
at least one parameter about periodic registration timer control for MICO mode.

38. The method of claim 37, further comprising:
receiving, from the service consumer, a first subscription request for event reporting about reachability of the terminal device; and
sending, to the UDM entity, a second subscription request for event reporting about reachability of the terminal device.

39. A method performed by a network node implementing a service consumer, the method comprising:
receiving, from a service provider, one or more reports indicating that one or more terminal devices are reachable, wherein each of the one or more reports contains a maximum availability time until which a terminal device is expected to be reachable; and
sending one or more messages to the one or more terminal devices based on the maximum availability times of the one or more terminal devices,
wherein the maximum availability time is derived based on a power saving configuration of the terminal device and wherein the power saving configuration of the terminal device comprises one or more of:
at least one parameter about extended connected time for mobile initiated connection only (MICO) mode;
at least one parameter about active time for MICO mode; and
at least one parameter about periodic registration timer control for MICO mode.

40. The method of claim 39, wherein a plurality of reports indicating that a plurality of terminal devices are reachable are received; and
wherein a plurality of messages are sent to the plurality of terminal devices by ordering the messages based on the maximum availability times of the plurality of terminal devices.

41. The method of claim 40, wherein the messages are ordered in an ascending order of the maximum availability times of the plurality of terminal devices; and
wherein the messages are sent to the plurality of terminal devices in the ascending order of the maximum availability times.

42. The method of claim 39, wherein the one or more messages are short message service, SMS, messages or the one or more messages are used for non-Internet protocol (non-IP) data delivery (NIDD).

43. The method of claim 39, wherein the service provider is one of: a unified data management (UDM) entity, a network exposure function (NEF) entity, an access and mobility management function (AMF) entity and a session management function (SMF) entity; and/or
wherein the service consumer is one of: a short message service (SMS) entity, an application function (AF) entity, a service capability server (SCS) entity, an application server (AS) entity, a network exposure function (NEF) entity, an SMF entity and a user plane function (UPF) entity.
